(19) United States
(12) Patent Application Publication
(10) Pub. No.: US 2017/0369659 A1
(43) Pub. Date: Dec. 28, 2017

(54) METHOD FOR MAKING CARBON NANOTUBE COMPOSITE STRUCTURE

(71) Applicants: Tsinghua University, Beijing (CN); HON HAI PRECISION INDUSTRY CO., LTD., New Taipei (TW)

(72) Inventors: KAI-LI JIANG, Beijing (CN); PENG LIU, Beijing (CN); WEN NING, Beijing (CN); JIA-PING WANG, Beijing (CN); SHOU-SHAN FAN, Beijing (CN)

(21) Appl. No.: 15/633,766

(22) Filed: Jun. 27, 2017

(30) Foreign Application Priority Data
Jun. 27, 2016 (CN) 201610477102.1

(51) Int. Cl. C08J 5/00; C08K 3/04; B29C 71/02; B05D 3/06; C08K 7/24; B82Y 40/00; B82Y 30/00

(52) U.S. Cl. CPC C08J 5/005; B05D 3/06; C08K 3/041; C08K 7/24; C08J 7/08; B82Y 30/00; B82Y 40/00; C08K 2201/011; Y10S 977/746; Y10S 977/847; C08J 2300/00

(57) ABSTRACT

A method for making a carbon nanotube composite structure includes providing a polymer substrate having a first surface and a second surface opposite to the first surface. A first carbon nanotube layer including a plurality of carbon nanotubes is placed on the first surface to form a preformed structure, wherein the carbon nanotube layer and the polymer substrate are stacked with each other. The preformed structure is scanned with a laser according to a predetermined pattern. The treated preformed structure includes a first part and a second part. The first part is scanned by the laser, and the second part is not scanned by the laser. The first part includes a plurality of first carbon nanotubes, and the second part includes a plurality of second carbon nanotubes. The plurality of second carbon nanotubes is removed.

### CROSS-REFERENCE TO RELATED APPLICATIONS

This application claims all benefits accruing under 35 U.S.C. §119 from China Patent Application No. 201610477102.1, filed on Jun. 27, 2016, in the China Intellectual Property Office, the disclosure of which is incorporated herein by reference.

### FIELD

The present application relates to a method for making carbon nanotube composite structure.

### BACKGROUND

Carbon nanotubes are a novel carbonaceous material having extremely small size and extremely large specific surface area. Carbon nanotubes have interesting and potentially useful electrical and mechanical properties, and have been widely used in various fields such as emitters, gas storage and separation, chemical sensors, and high strength composites.

US20120251766A1 discloses a method for forming a carbon nanotube composite. The method includes the following steps. A substrate having a surface is provided. A carbon nanotube structure is disposed on the surface of the substrate. The carbon nanotube structure includes a number of carbon nanotubes. The carbon nanotubes define a number of micro gaps. The substrate and the carbon nanotube structure are disposed in an environment filled with electromagnetic waves such that the surface of the substrate is melted and is permeated into the micro gaps. However, a patterned carbon nanotube composite structure cannot be formed in US20120251766A1.

What is needed, therefore, is to provide a method for making carbon nanotube composite structure that can overcome the above-described shortcomings.

### BRIEF DESCRIPTION OF THE DRAWINGS

Implementations of the present technology will now be described, by way of example only, with reference to the attached figures, wherein:

FIG. 1 is a schematic process flow of one embodiment of a method for making a carbon nanotube composite structure.

FIG. 2 is a scanning electron microscope (SEM) image of a drawn carbon nanotube film.

FIG. 3 is an SEM image of a flocculated carbon nanotube film.

FIG. 4 an SEM image of a pressed carbon nanotube film including a plurality of carbon nanotubes arranged along a same direction.

FIG. 5 is an SEM image of a pressed carbon nanotube film including a plurality of carbon nanotubes which is arranged along different direction.

FIG. 6 is an schematic view of one embodiment of a carbon nanotube composite structure having a pattern which is a term “TFNRC”.

FIG. 7 is an optical photograph of the carbon nanotube composite structure which is formed by the method of FIG. 1.

FIG. 8 is a schematic process flow of another embodiment of a method for making a carbon nanotube composite structure.

FIG. 9 is a schematic process flow of yet another embodiment of a method for making a carbon nanotube composite structure.

FIG. 10 is a schematic process flow of yet another embodiment of a method for making a carbon nanotube composite structure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to illustrate details and features better. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

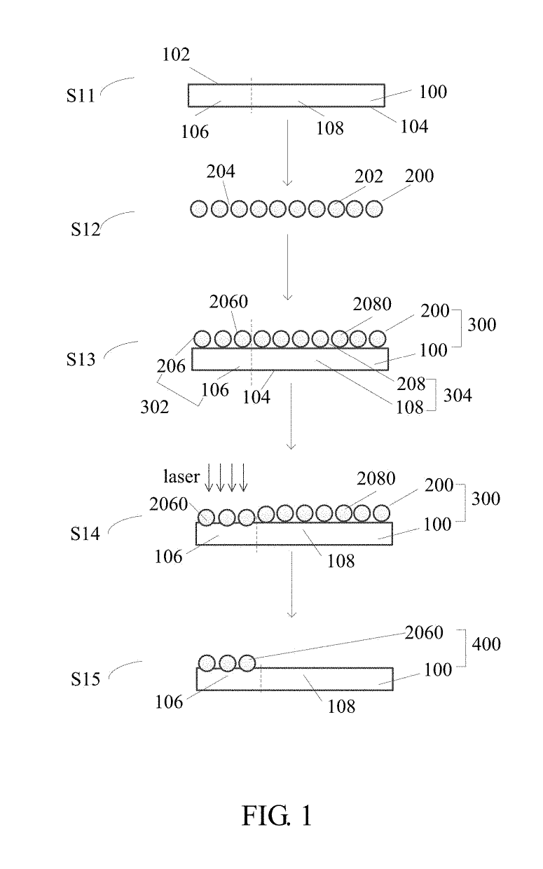

Referring to FIG. 1, a method for making a carbon nanotube composite structure 400 of one embodiment includes steps of:

S11, providing a polymer substrate 100, wherein the polymer substrate 100 has a first surface 102 and a second surface 104 opposite to the first surface 102, the polymer substrate 100 defines a first substrate part 106 and a second substrate part 108, and the first substrate part 106 and the second substrate part 108 form the polymer substrate 100;

S12, providing a carbon nanotube layer 200, wherein the carbon nanotube layer 200 includes a plurality of carbon nanotubes 202, and a gap 204 is defined between two adjacent carbon nanotubes 202;

S13, placing the carbon nanotube layer 200 on the first surface 102 of the polymer substrate 100 to form a preformed structure 300, wherein the carbon nanotube layer 200 and the polymer substrate 100 are stacked with each other; the preformed structure 300 defines a first part 302 and a second part 304, the first part 302 includes the first substrate part 106 and a first layer part 206 located on the first substrate part 106, the second part 304 includes the second substrate part 108 and a second layer part 208 located on the second substrate part 108; the first layer part 206 includes a plurality of first carbon nanotubes 2060, and the second layer part 208 includes a plurality of second carbon nanotubes 2080; and the first layer part 206 and the second layer part 208 form the carbon nanotube layer 200, and the plurality of first carbon nanotubes 2060 and the plurality of second carbon nanotubes 2080 form the plurality of carbon nanotubes 202;

S14, irradiating only the first layer part 206 in the first part 302 by a laser, wherein the plurality of first carbon nanotubes 2060 converts the light energy from the laser to heat energy, to heat the first substrate part 106, so that the first substrate part 106 is melted and bonded with the plurality of first carbon nanotubes 2060; and

S15, removing the plurality of second carbon nanotubes 2080.

In the step S11, the material of the polymer substrate 100 can be polyethylene terephthalate (PET), polystyrene, polyethylene, epoxy, bismaleimide resin, cyanate resin, polypropylene, polyvinyl alcohol, polystyrene, polycarbonate, and polymethylmethacrylate. The polymer substrate 100 having a suitable melting point can be selected according to the environment of scanning the preformed structure 300. When the preformed structure 300 is scanned with the laser in the presence of a vacuum or a protecting gas, the melting point of the polymer substrate 100 is not limited. When the preformed structure 300 is scanned with the laser in air, in order to protect the carbon nanotube 202 from destruction, the melting point of the polymer substrate 100 is less than 600 degrees Celsius. The first surface 102 can be a smooth planar surface or a curved surface. In one embodiment, the material of the polymer substrate 100 is PET, the polymer substrate 100 is a rectangular parallelepiped having a thickness of about 3 mm and a side length of about 50 mm, and the first surface 102 is a square plane having a side length of about 50 mm.

In the step S12, The plurality of carbon nanotubes 202 uniformly distributed therein. The plurality of carbon nanotubes 202 can be combined by van der Waals attractive force. The carbon nanotube layer 200 can be a substantially pure structure of the carbon nanotubes 202, with few impurities. The plurality of carbon nanotubes 202 may be single-walled, double-walled, multi-walled carbon nanotubes 202, or their combinations. The carbon nanotubes 202 which are single-walled have a diameter of about 0.5 nanometers (nm) to about 50 nm. The carbon nanotubes 202 which are double-walled have a diameter of about 1.0 nm to about 50 nm. The carbon nanotubes 202 which are multi-walled have a diameter of about 1.5 nm to about 50 nm.

The carbon nanotubes 202 can be orderly or disorderly arranged. The term ‘disordered carbon nanotube’ refers to the carbon nanotube layer 200 where the carbon nanotubes 202 are arranged along many different directions, and the aligning directions of the carbon nanotubes 202 are random. The number of the carbon nanotubes 202 arranged along each different direction can be almost the same (e.g. uniformly disordered). The carbon nanotubes 202 can be entangled with each other. The term ‘ordered carbon nanotube’ refers to the carbon nanotube layer 200 where the carbon nanotubes 202 are arranged in a consistently systematic manner, e.g., the carbon nanotubes 202 are arranged approximately along a same direction and/or have two or more sections within each of which the carbon nanotubes 202 are arranged approximately along a same direction (different sections can have different directions). The carbon nanotube layer 200 can be a plurality of drawn carbon nanotube films, a plurality of flocculated carbon nanotube films, or a plurality of pressed carbon nanotube films.

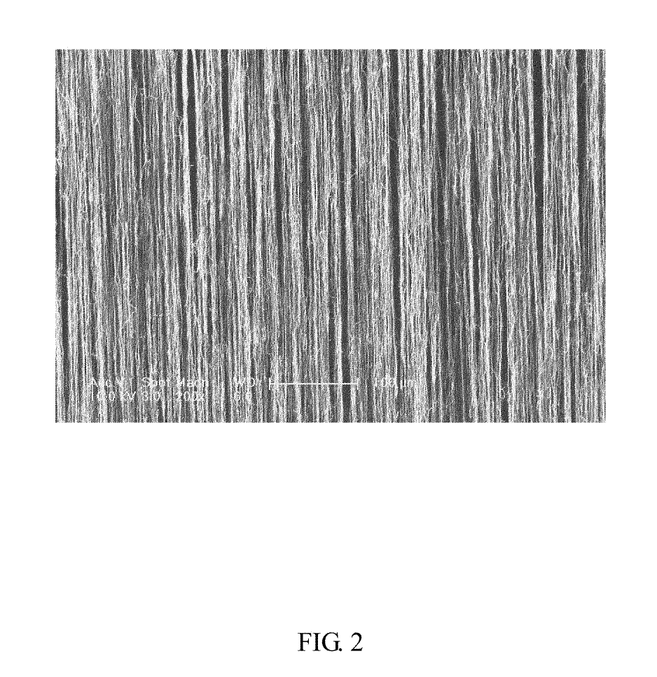

Referring to FIG. 2, the drawn carbon nanotube film includes a plurality of successive and oriented carbon nanotubes 202 joined end-to-end by van der Waals attractive force therebetween. The carbon nanotubes 202 in the drawn carbon nanotube film are oriented along a preferred orientation. The carbon nanotubes 202 are parallel to a surface of the drawn carbon nanotube film. The drawn carbon nanotube film is a free-standing film. The drawn carbon nanotube film can bend to desired shapes without breaking. A film can be drawn from a carbon nanotube array to form the drawn carbon nanotube film.

If the carbon nanotube layer 200 includes at least two stacked drawn carbon nanotube films, adjacent drawn carbon nanotube films can be combined by only the van der Waals attractive force therebetween. Additionally, when the carbon nanotubes 202 in the drawn carbon nanotube film are aligned along one preferred orientation, an angle can exist between the orientations of carbon nanotubes 202 in adjacent drawn carbon nanotube films, whether stacked or adjacent. An angle between the aligned directions of the carbon nanotubes 202 in two adjacent drawn carbon nanotube films can be in a range from about 0 degrees to about 90 degrees. Stacking the drawn carbon nanotube films will improve the mechanical strength of the carbon nanotube composite structure 400.

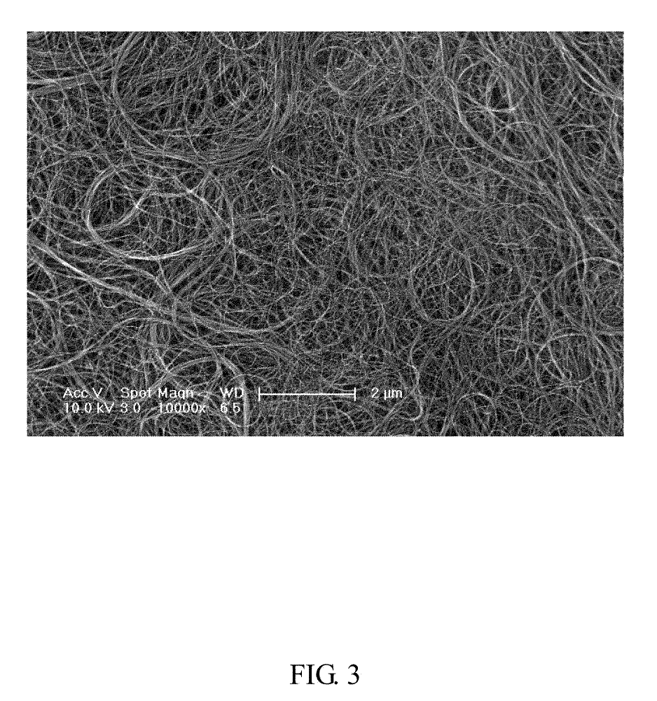

Referring to FIG. 3, the flocculated carbon nanotube film includes a plurality of long, curved, disordered carbon nanotubes 202 entangled with each other. The flocculated carbon nanotube film can be isotropic. The carbon nanotubes 202 can be substantially uniformly dispersed in the flocculated carbon nanotube film. Adjacent carbon nanotubes 202 are acted upon by van der Waals attractive force to obtain an entangled structure. Due to the carbon nanotubes 202 in the flocculated carbon nanotube film being entangled with each other, the flocculated carbon nanotube film has excellent durability, and can be fashioned into desired shapes with a low risk to the integrity of the flocculated carbon nanotube film. Further, the flocculated carbon nanotube film is a free-standing film.

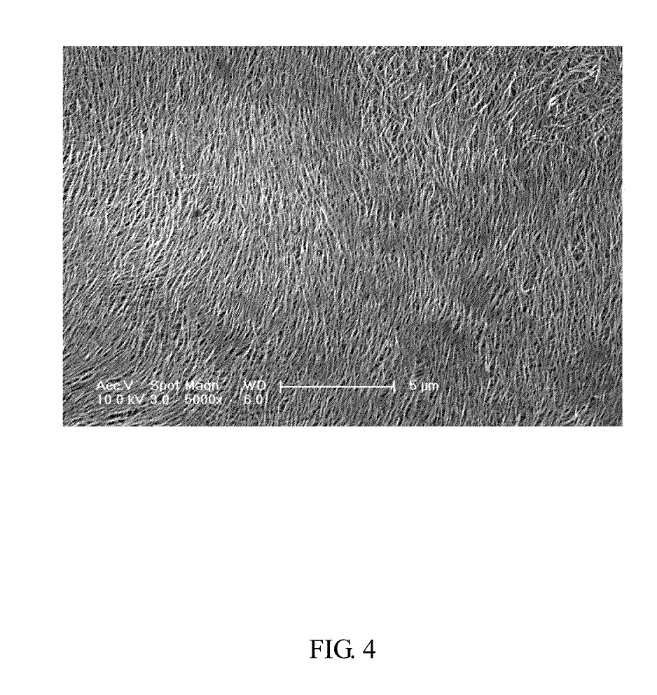

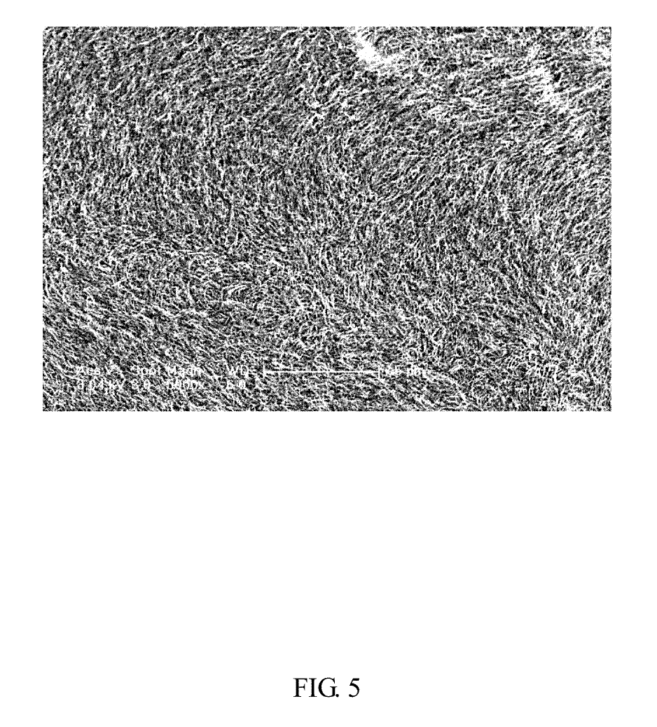

Referring to FIGS. 4 and 5, the carbon nanotubes 202 in the pressed carbon nanotube film can be arranged along the same direction, as shown in FIG. 4. The carbon nanotubes 202 in the pressed carbon nanotube film can be arranged along different directions, as shown in FIG. 5. The carbon nanotubes 202 in the pressed carbon nanotube film can rest upon each other. An angle between a primary alignment direction of the carbon nanotubes 202 and a surface of the pressed carbon nanotube film is about 0 degrees to approximately 15 degrees. The greater the pressure applied, the smaller the angle obtained. If the carbon nanotubes 202 in the pressed carbon nanotube film are arranged along different directions, the pressed carbon nanotube film can have properties that are identical in all directions substantially parallel to the surface of the pressed carbon nanotube film. Adjacent carbon nanotubes 202 are attracted to each other and are joined by van der Waals attractive force. Therefore, the pressed carbon nanotube film is easy to bend to desired shapes without breaking. Further, the pressed carbon nanotube film is a free-standing film.

The term “free-standing” includes, but not limited to, the carbon nanotube layer 200 that does not have to be supported by a substrate. For example, the free-standing carbon nanotube layer 200 can sustain the weight of itself when it is hoisted by a portion thereof without any significant damage to its structural integrity. So, if the free-standing carbon nanotube layer 200 is placed between two separate supporters, a portion of the free-standing carbon nanotube layer 200, not in contact with the two supporters, would be suspended between the two supporters and yet maintain film structural integrity.

In the step S13, in one embodiment, the plurality of carbon nanotubes 202 are parallel to the first surface 102 of the polymer substrate 100. The method for placing the carbon nanotube layer 200 on the first surface 102 of the polymer substrate 100 is not limited. The present application discloses three embodiments of methods for placing the carbon nanotube layer 200 on the first surface 102 of the polymer substrate 100.

One embodiment of method:

The carbon nanotube layer 200 is directly stuck on the first surface 102 of the polymer substrate 100 by electrostatic adsorption.

Another embodiment of method:

The organic solvent is first dropped on the first surface 102 of the polymer substrate 100 by a test tube or the like, and then the carbon nanotube layer 200 is placed on the first surface 102 of the polymer substrate 100. The carbon nanotube layer 200 and the polymer substrate 100 are stacked with each other. After the organic solvent is volatilized, the carbon nanotube layer 200 can be adhered to the polymer substrate 100 under the surface tension of the organic solvent. The gaps 204 in the carbon nanotube layer 200 have larger size under the surface tension of the organic solvent. In the subsequent laser scanning, it is advantageous to allow the molten first substrate part 106 pass through the gaps 204 to enclose each of the plurality of first carbon nanotube 2060. The organic solvent can be ethanol, methanol, acetone, dichloroethane or chloroform.

Yet another embodiment of method:

The carbon nanotube layer 200 is first placed on the first surface 102 of the polymer substrate 100, and then the organic solvent is dropped on the carbon nanotube layer 200 by the test tube or the like. The carbon nanotube layer 200 and the polymer substrate 100 are stacked with each other. After the organic solvent is volatilized, the carbon nanotube layer 200 can be adhered to the polymer substrate 100 under the surface tension of the organic solvent. The gaps 204 in the carbon nanotube layer 200 have larger size under the surface tension of the organic solvent. In the subsequent laser scanning, it is advantageous to allow the molten first substrate part 106 pass through the gaps 204 to enclose each of the plurality of first carbon nanotube 2060.

In the step S14, irradiating only the first layer part 206 in the first part 302 is that the first part 302 is scanned and the second part 304 is not scanned when scanning the preformed structure 300. The present application discloses two embodiments of methods for irradiating only the first layer part 206. One embodiment of method: the preformed structure 300 is irradiated with the laser from side of the first layer part 206, so that the first layer part 206 is directly irradiated by the laser. In this case, the material of the polymer substrate 100 is not limited. Another embodiment of method: the preformed structure 300 is irradiated with the laser from side of the first substrate part 106, so that the laser passes through the first substrate part 106 to irradiate the first layer part 206. In this case, the material of the polymer substrate 100 should be transparent and dose not absorb the laser. In one embodiment, the material of the polymer substrate 100 is polyethylene.

Scanning the preformed structure 300 with the laser includes sub-steps below:

S141, providing a laser device to emit the laser, wherein the moving of the laser device can be controlled the computer program;

S142, inputting a predetermined pattern of the first layer part 206 into the computer program; and

S143, scanning the preformed structure 300 with the laser at a predetermined speed along the predetermined pattern of the first layer part 206.

In the step S143, in the part which is not scanned by the laser, the polymer substrate 100 and the carbon nanotube layer 200 are not bonded with each other. The part which is not scanned by the laser is the second part 304. In the part which is scanned by the laser, the polymer substrate 100 and the carbon nanotube layer 200 are bonded with each other. The part which is scanned by the laser is the first part 302.

The frequency of the laser device is greater than or equal to 300 THz. The power ratio of the laser device can be in a range from about 20% to about 150%, and the power ratio is that the ratio of the using power and the full power. The moving speed of the laser can be in a range from about 1 mm/s to about 150 mm/s. In one embodiment, the moving speed of the laser can be in a range from about 50 mm/s to about 150 mm/s. The working distance between the laser device and the preformed structure 300 can be in a range from about 1 mm to about 1000 mm. In one embodiment, the working distance between the laser device and the preformed structure 300 can be in a range from about 240 mm to about 255 mm. In one embodiment, the laser device is a YAG laser device, the power of the YAG laser device is about 1.2 W, the moving speed of the YAG laser is about 100 mm/s, the frequency of the YAG laser device is about 300 THz, and the working distance between the laser device and the preformed structure 300 is about 250 mm. Alternatively, in step S143, the scanning can also be carried out by fixing the laser and moving the preformed structure 300.

The principle of forming the patterned carbon nanotube composite structure 400 is as follows:

The material of the polymer substrate 100 is polymer, and the heat capacity of the polymer is much larger than the heat capacity of the carbon nanotube layer 200. When the preformed structure 300 is scanned by the laser according to the predetermined pattern, the first part 302 is scanned by the laser, and the second part 304 is not scanned by the laser.

In the first part 302, after absorbing the heat energy of the laser by the plurality of first carbon nanotubes 2060, the temperature of the plurality of first carbon nanotubes 2060 rapidly increases so that the temperature of the surface of the first substrate part 106 also increases, because the first layer part 206 is in direct contact with the surface of the first substrate part 106. Therefore, the plurality of first carbon nanotubes 2060 absorbs the laser and converts the light energy to heat energy, to heat the first substrate part 106. Furthermore, in the first part 302, the first substrate part 106 itself absorbs the heat energy from the laser. After the surface of the first substrate part 106 reaches a certain temperature, the surface of the first substrate part 106 begins to melt. When the surface of the first substrate part 106 is melted, the contact between the outer wall of the plurality of first carbon nanotubes 2060 and the first substrate part 106 is much better, so that the interfacial thermal resistance between the outer wall of the plurality of first carbon nanotubes 2060 and the first substrate part 106 is significantly reduced. Thus, a greater heat energy enters the first substrate part 106. Thus, in the first part 302, the first substrate part 106 absorbs heat energy, expands, and melts. The molten first substrate part 106 is adhered to or welded together with the plurality of first carbon nanotubes 2060, and even the molten first substrate part 106 penetrates into the gap 204 to surround each of the plurality of first carbon nanotubes 2060.

In the second part 304, the second substrate part 108 cannot be melted, cannot be bonded with the plurality of second carbon nanotubes 2080, and cannot surround the plurality of second carbon nanotubes 2080. The reason is that: when the laser irradiates the first part 302 and does not irradiate the second part 304, the plurality of first carbon nanotubes 2060 of the first layer part 206 absorbs the laser to form the heat energy, the thermal conductivity of the polymer is generally small, so that the heat energy is difficult to be spread to the second substrate part 108. Thus, the second substrate part 108 of the second part 304 does not get the heat energy to melt.

The environment of scanning the preformed structure 300 with the laser is not limited, such as air environment, vacuum environment, or protecting gas environment. When the preformed structure 300 is scanned with the laser in air environment, the melting point of the polymer substrate 100 is less than the melting point of the plurality of carbon nanotubes 202, in order to prevent the carbon nanotube layer 200 from being oxidized. In one embodiment, the melting point of the polymer substrate 100 is less than 600 degrees Celsius. When the preformed structure 300 is scanned with the laser in the vacuum or the protecting gas environment, the melting point of the polymer substrate 100 is not limited, because the plurality of carbon nanotubes 202 cannot be oxidized by the laser in the vacuum or the protecting gas environment. The vacuum value in the vacuum environment can be in a range from about 10⁻⁶ Pa to about 10⁻² Pa. The protecting gas can be nitrogen or an inert gas.

In the step S15, the method for removing the plurality of second carbon nanotubes 2080 of the second part 304 is not limited, such as etching, removing by tape, and the like. In one embodiment, the plurality of second carbon nanotubes 2080 are removed by the tape. In another embodiment, the plurality of second carbon nanotubes 2080 are etched. Etching the plurality of second carbon nanotubes 2080 includes steps below:

S151, providing a mask having a plurality of openings;

S152, placing the mask on the scanned preformed structure 300 after scanning the preformed structure 300 with the laser, wherein the plurality of second carbon nanotubes 2080 is exposed from the plurality of openings;

S153, etching the plurality of second carbon nanotubes 2080; and

S154, removing the mask.

In the step S154, the mask can be directly peeled off. The mask can be removed with a solvent capable of dissolving the mask but not dissolving the plurality of second carbon nanotubes 2080 and the polymer substrate 100.

It is understood that the step S15 is an optional step, and the step S15 can be omitted.

In one embodiment, five carbon nanotube composite structures 400 are prepared and named as sample 1, sample 2, sample 3, sample 4, and sample 5 respectively. Table 1 shows some parameters of sample 1, sample 2, sample 3, sample 4, and sample 5. The term “2X” means that the carbon nanotube layer 200 consists of two stacked drawn carbon nanotube films, and the angle between the aligned directions of the carbon nanotubes 202 in two drawn carbon nanotube films is greater than 0 degrees. The term “smooth” means that the first surface 102 of the polymer substrate 100 is smooth. The term “unsmooth” means that the first surface 102 of the polymer substrate 100 is not smooth. The symbol “√” refers to that the carbon nanotube composite structures 400 is formed. The symbol “x” refers to that the carbon nanotube composite structures 400 is not formed.

TABLE 1

| parameter | sample 1 | | sample 2 | | sample 3 | | sample 4 | | sample 5 | |
|---|---|---|---|---|---|---|---|---|---|---|
| environment | vacuum | | vacuum | | vacuum | | air | | air | |
| of scanning | | | | | | | | | | |
| moving speed | 100 | mm/s | 100 | mm/s | 100 | mm/s | 100 | mm/s | 100 | mm/s |
| of the laser | | | | | | | | | | |
| working | 250 | mm | 250 | mm | 250 | mm | 250 | mm | 237 | mm |

| | | | | | |
|---|---|---|---|---|---|
| distance | | | | | |
| power ratio | 30% | 30% | 100% | 100% | 100% |
| of the laser | | | | | |
| Number of | 1 | 2 X | 2 X | 2 X | 2 X |
| the carbon | | | | | |
| nanotube film | | | | | |
| first surface | smooth | smooth | smooth | smooth | unsmooth |
| 102 | | | | | |
| carbon | √ | × | √ | √ | × |
| nanotube | | | | | |
| composite | | | | | |
| structures 400 | | | | | |

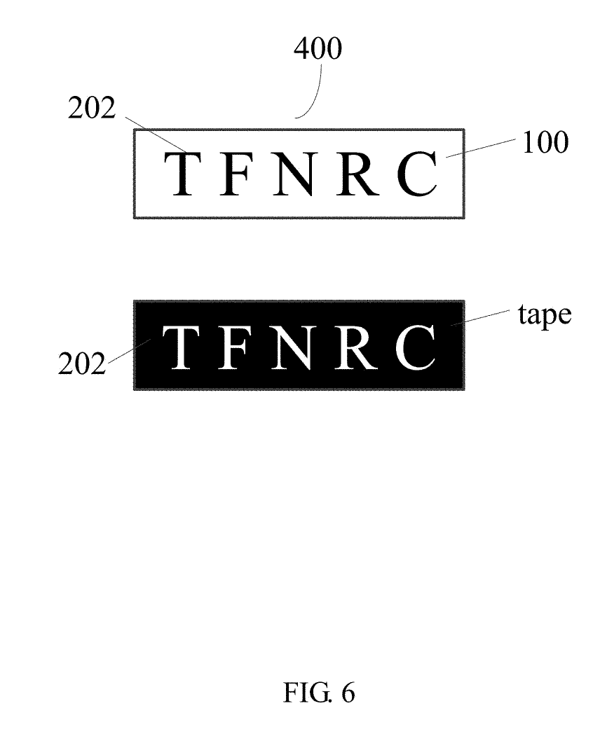

FIG. 6 shows a carbon nanotube composite structure 400 having a pattern which is a term “TFNRC”. The term “TFNRC” is formed by bonding the plurality of first carbon nanotubes 2060 and the first substrate part 106. In making the carbon nanotube composite structure 400 having the term “TFNRC”, the plurality of second carbon nanotubes 2080 is removed by the tape. Thus, the plurality of second carbon nanotubes 2080 also form a pattern on the tape, as shown in FIG. 6.

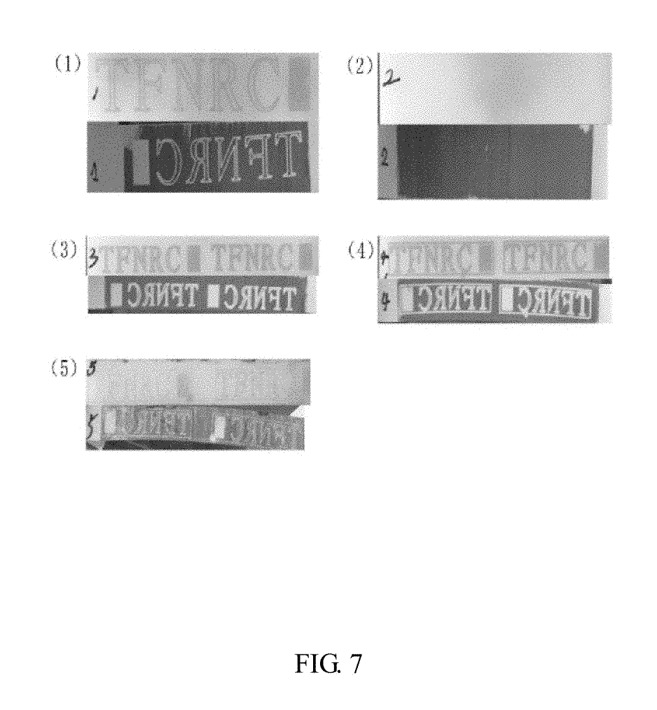

Referring to FIG. 7, there are five small figures in FIG. 7, and the five small figures named as figure (1), figure (2), figure (3), figure (4), and figure (5) respectively. the upper half parts of the figure (1), figure (2), figure (3), figure (4), and figure (5) are the sample 1, sample 2, sample 3, sample 4, and sample 5 respectively. In the upper half parts of the figure (1), figure (2), figure (3), figure (4), and figure (5), the plurality of second carbon nanotubes 2080 is removed by the tape. Referring to figure (7, the lower half parts of the figure (1), figure (2), figure (3), figure (4), and figure (5) are some patterns formed by the plurality of second carbon nanotubes 2080 on the tape.

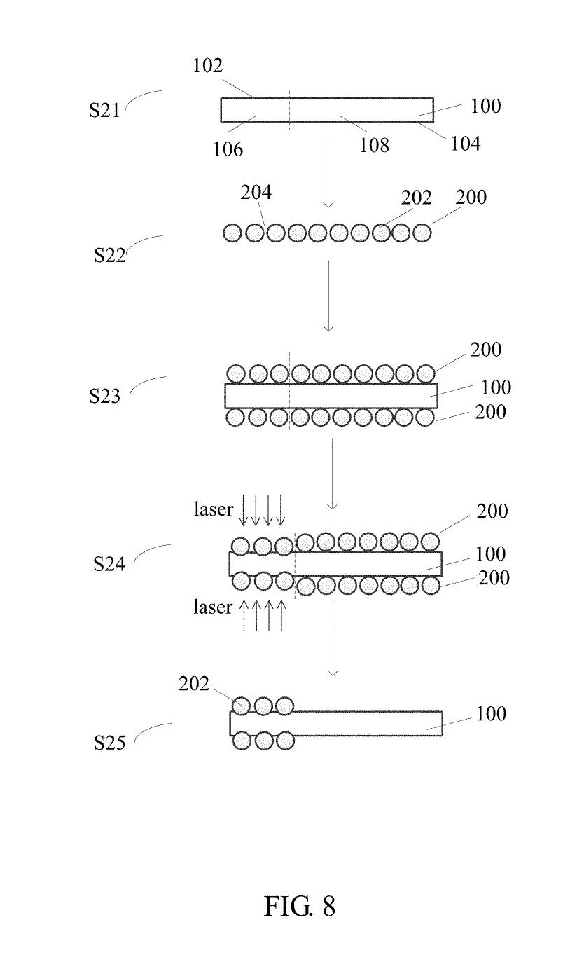

Referring to FIG. 8, an embodiment of the method for making the carbon nanotube composite structure 400 is shown where the second surface 104 is also covered by the carbon nanotube layer 200, and the carbon nanotube layer 200 located on the second surface 104 is also scanned by the laser. Two opposite surfaces of the polymer substrate 100 are respectively covered the carbon nanotube layer 200 and are respectively scanned. Thus, the two opposite surfaces of the polymer substrate 100 can be patterned. The pattern in the first surface 102 and the pattern in the second surface 104 can be the same or can be different.

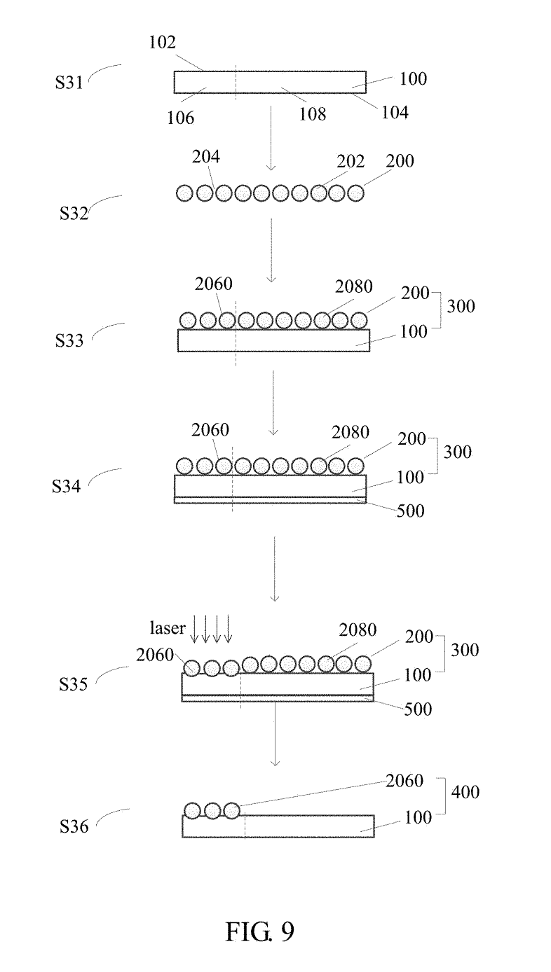

Referring to FIG. 9, an embodiment of the method for making the carbon nanotube composite structure 400 is shown where a reflective layer 500 can be located on the second surface 104. The preformed structure 300 can be irradiated with the laser only from side of the first layer part 206, because the reflective layer 500 is located on the second surface 104.

The reflective layer 500 can be configured for reflecting the heat emitted by the plurality of first carbon nanotubes 2060 in the first layer part 206, and controlling the direction of heat from the first layer part 206 for single-side heating. The efficiency for heating the first substrate part 106 can be increased. When the reflective layer 500 is configured for reflecting the heat emitted by the plurality of first carbon nanotubes 2060, the material of the reflective layer 500 can be selected from one of metal oxides, metal salts, and ceramics. In one embodiment, the reflective layer 500 is an aluminum oxide (Al₂O₃) film. Furthermore, the reflective layer 500 can be removed after scanning the preformed structure 300 by the laser. The method for removing the reflective layer 500 is not limited, such as peeling off, or etching.

The reflective layer 500 can be configured for reflecting the laser, that has passed through the first layer part 206, back to the first layer part 206. The material of the reflective layer 500 is not limited, such as silver.

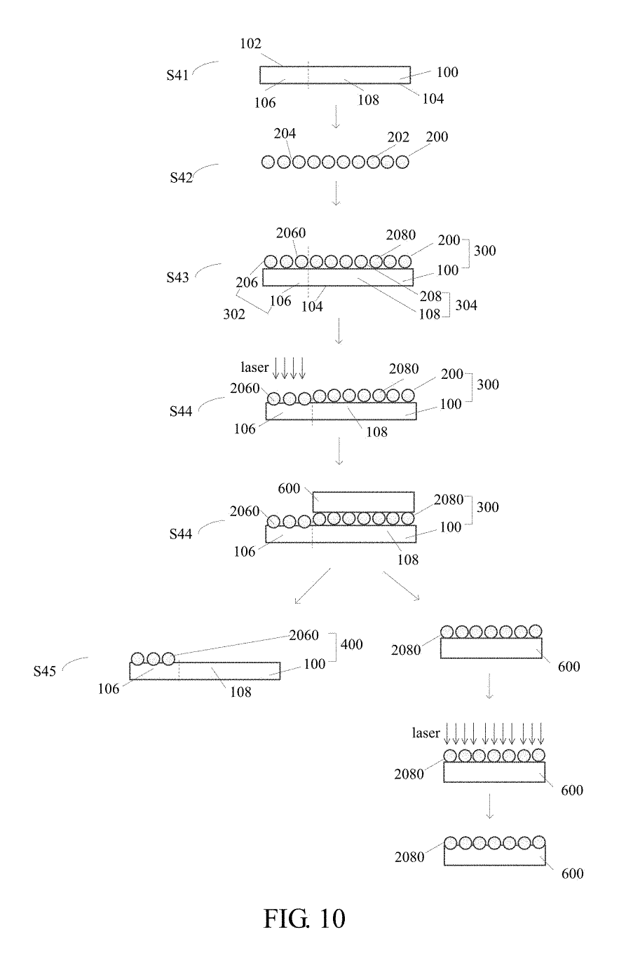

Referring to FIG. 10, an embodiment of the method for making the carbon nanotube composite structure 400 is shown where the plurality of second carbon nanotubes 2080 is removed by a base 600. The base 600 has a viscosity and can adhere the plurality of second carbon nanotubes 2080. Furthermore, the plurality of second carbon nanotubes 2080 on the base 600 is irradiated by the laser after removing the plurality of second carbon nanotubes 2080 by the base 600. The plurality of second carbon nanotubes 2080 can absorbs the laser and converts the light energy to heat energy, so that the base 600 is heated by the heat energy to melt. The molten base 600 can penetrate into the gap 204 to surround each of the plurality of second carbon nanotubes 2080.

The material of the base 600 can be a polymer having viscosity, such as epoxy resin, phenolic resin, urea resin, melamine-formaldehyde resin, silicone resin, furan resin, unsaturated polyester, acrylic resin, polyimide, polybenzimidazole, phenolic-polyvinyl acetal, Phenolic-polyamide, phenolic-epoxy resin.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Additionally, it is also to be understood that the above description and the claims drawn to a method may include some indication in reference to certain steps. However, the indication used is only to be viewed for identification purposes and not as a suggestion as to an order for the steps.

What is claimed is:

1. A method for making a carbon nanotube composite structure, the method comprising:
providing a polymer substrate having a first surface and a second surface opposite to the first surface, wherein the polymer substrate defines a first substrate part and a second substrate part;
placing a first carbon nanotube layer on the first surface, wherein the first carbon nanotube layer defines a first layer part comprising a plurality of first carbon nanotubes and a second layer part comprising a plurality of second carbon nanotubes, the first layer part is located on the first substrate part, and the second layer part is located on the second substrate part;
irradiating only the first layer part by a laser; and
removing the plurality of second carbon nanotubes.

2. The method of claim 1, wherein the polymer substrate and the carbon nanotube layer are stacked with each other before irradiating only the first layer part by the laser.

3. The method of claim 1, wherein a gap is defined between two adjacent first carbon nanotubes.

4. The method of claim 3, wherein in process of irradiating only the first layer part by the laser, the first substrate part is melted and penetrates into the gap to surround each of the plurality of first carbon nanotubes.

5. The method of claim 1, wherein in process of irradiating only the first layer part by the laser, the plurality of first carbon nanotubes absorbs the laser and generates heat energy to heat the first substrate part, so that the first substrate part is melted and bonded with the plurality of first carbon nanotubes.

6. The method of claim 1, wherein in process of irradiating only the first layer part by the laser, the second substrate part is not melted, and is not bonded with the plurality of second carbon nanotubes.

7. The method of claim 1, wherein the plurality of first carbon nanotubes and the plurality of second carbon nanotubes are parallel to the first surface.

8. The method of claim 1, wherein the irradiating only the first layer part by the laser comprises irradiating the first layer part from side of the first layer part, so that the first layer part is directly irradiated by the laser.

9. The method of claim 1, wherein the irradiating only the first layer part by the laser comprises irradiating the first layer part from side of the first substrate part, so that the laser passes through the first substrate part to irradiate the first layer part, and a material of the first substrate part is transparent.

10. The method of claim 1, wherein the irradiating only the first layer part by the laser is performed in an air environment, and a melting point of the polymer substrate is less than a melting point of the plurality of first carbon nanotubes.

11. The method of claim 1, wherein the irradiating only the first layer part by the laser is performed in a vacuum environment, and a vacuum value is in a range from about 10⁻⁶ Pa to about 10⁻² Pa.

12. The method of claim 1, wherein the plurality of second carbon nanotubes is removed by etching.

13. The method of claim 1, wherein the plurality of second carbon nanotubes is removed by a tape.

14. The method of claim 1, further comprising placing a second carbon nanotube layer on the second surface, and irradiating the second carbon nanotube layer with the laser.

15. The method of claim 1, further comprising locating a reflective layer on the second surface, and a material of the reflective layer is selected from a group consisting of metal oxides, metal salts, and ceramics.

16. The method of claim 1, wherein the removing the plurality of second carbon nanotubes comprises:
placing a base on the second substrate part, wherein a material of the base is a polymer having a viscosity so that the plurality of second carbon nanotubes are bonded on the base;
removing the base from the second substrate part, wherein the plurality of second carbon nanotubes are bonded on the base and removed from the second substrate part together with the base.

17. The method of claim 16, wherein the plurality of second carbon nanotubes on the base is irradiated by the laser after removing the base from the second substrate part.

18. The method of claim 17, wherein the plurality of second carbon nanotubes absorbs the laser and generates a heat energy to heat the base, and the base is melted and surround each of the plurality of second carbon nanotubes.
